(19) United States
(12) Patent Application Publication
(10) Pub. No.: US 2024/0234021 A1
(43) Pub. Date: Jul. 11, 2024

(54) INDUCTOR COMPONENT

(71) Applicant: Murata Manufacturing Co., Ltd., Kyoto-fu (JP)

(72) Inventor: Atsushi SEKO, Nagaokakyo-shi (JP)

(73) Assignee: Murata Manufacturing Co., Ltd., Kyoto-fu (JP)

(21) Appl. No.: 18/403,330

(22) Filed: Jan. 3, 2024

(30) Foreign Application Priority Data
Jan. 11, 2023 (JP) 2023-002462

(51) Int. Cl. H01F 27/32; H01F 27/28

(52) U.S. Cl. CPC H01F 27/323; H01F 27/2804

(57) ABSTRACT

An inductor component includes a base body including an insulating layer, internal wiring provided inside the base body and constituting a coil spirally wound by electrically coupling at least part of the internal wiring, and an outer electrode electrically coupled to the coil. The insulating layer is provided with a groove starting from an interface, as a point of origin, between the internal wiring and the insulating layer and extending obliquely with respect to a surface of the internal wiring.

### CROSS-REFERENCE TO RELATED APPLICATION

This application claims benefit of priority to Japanese Patent Application No. 2023-002462, filed Jan. 11, 2023, the entire content of which is incorporated herein by reference.

### BACKGROUND

### Technical Field

The present disclosure relates to an inductor component.

### Background Art

Japanese Patent No. 5459327 discloses an electronic component. The electric component includes a multilayer body and a coil. The coil has a helical shape and is provided in the multilayer body. The coil is made of coil conductor layers that are superposed with one another and form a ring-shaped path in plan view in a direction of lamination and of via hole conductors that connect the coil conductor layers to one another. The ring-shaped path includes first corners that project outward and second corners that project inward, and all of the via hole conductors are provided at the first corners.

Japanese Patent No. 6787286 discloses a method of manufacturing an inductor component. The method includes preparing conductive paste and photosensitive insulating paste that includes a filler material composed of quartz, a glass material, and a resin material, forming a first insulating layer by applying the insulating paste, exposing the first insulating layer in a state where a first portion of the first insulating layer is shielded by a mask, removing the first portion of the first insulating layer to form a groove having a groove depth larger than a groove width at a position corresponding to the first portion, applying the conductive paste in the groove to form a coil conductor layer in the groove, and applying the insulating paste on the first insulating layer and on the coil conductor layer to form a second insulating layer.

### SUMMARY

Improvements in performance of various devices such as communication devices require further improvements in performance not only for substrates and the like that constitute the devices but also for inductor components to be mounted on the substrates and the like. For example, an inductor component used in a high frequency band is required to reduce wiring resistance in order to realize excellent coil characteristics.

However, an investigation conducted by the inventor of the present disclosure has revealed that it is difficult to increase a thickness of internal wiring as in the case of Japanese Patent No. 6787286 forming the internal wiring (including coil wiring) on an insulating layer in the process of manufacturing the inductor component due to the following reasons: (1) there is a limitation in thickly coating a conductive material constituting the internal wiring; and (2) even when the conductive material constituting the internal wiring can be thickly coated, there is a limitation in coating an insulating material that constitutes an insulating layer in such a way as to cover the internal wiring. As a consequence, it is found to be difficult to achieve low resistance of the internal wiring.

On the other hand, another investigation conducted by the inventor of the present disclosure has revealed that internal wiring having a large thickness can be formed, as in the process of manufacturing an inductor component in Japanese Patent No. 6787286, by providing an insulating layer with a groove having a groove depth being larger than a groove width, and then coating a conductive material on the insulating layer while filling the groove with the conductive material. As a consequence, it is found possible to achieve low resistance of the internal wiring.

However, this investigation by the inventor has also revealed that a stress is likely to occur on an interface between the internal wiring and the insulating layer in the case of forming the internal wiring having the large thickness as in Japanese Patent No. 6787286 in the manufacturing process of the inductor component because a difference in amount of thermal contraction between the internal wiring and the insulating layer grows larger due to an increase in volume ratio of the internal wiring relative to a base body. The following phenomena have also been determined. Specifically, in the case where the size of the inductor component is reduced or the internal wiring is formed to have a thick film, when a stress occurs on an interface between the internal wiring and the insulating layer in the manufacturing process of the inductor component, a thermal shock may be applied to the inductor component in, for example, a firing step in the manufacturing process of the inductor component and a reflow step in a mounting process of the inductor component, and a physical load (a mechanical load) may be applied to the inductor component in other steps. Accordingly, delamination may occur on the interface between the internal wiring and the insulating layer due to the stress occurring on the interface between the internal wiring and the insulating layer, thereby as a consequence possibly developing cracks along the internal wiring inside the base body. In addition, it has also turned out that moisture, corrosive gas, or the like may enter the inside of the base body via the cracks when the cracks reach a surface of the base body, thereby possibly deteriorating reliability of the inductor component.

The present disclosure has been made in view of the aforementioned problems. Accordingly, the present disclosure provides an inductor component which is capable of suppressing development of cracks attributed to a stress that may occur on an interface between internal wiring and an insulating layer.

An inductor component of the present disclosure includes a base body including an insulating layer, internal wiring provided inside the base body and constituting a coil spirally wound by electrically coupling at least part of the internal wiring, and an outer electrode electrically coupled to the coil. The insulating layer is provided with a groove starting from an interface, as a point of origin, between the internal wiring and the insulating layer and extending obliquely with respect to a surface of the internal wiring.

According to the present disclosure, it is possible to provide an inductor component which is capable of suppressing development of cracks attributed to a stress that may occur on an interface between internal wiring and an insulating layer.

### BRIEF DESCRIPTION OF THE DRAWINGS

FIG. 1 is a schematic perspective view illustrating an example of an inductor component of Embodiment 1 of the present disclosure;

FIG. 2 is a schematic sectional view illustrating an example of a cross-section taken along the a1-a2 line of the inductor component illustrated in FIG. 1;

FIG. 3 is a schematic sectional view illustrating an example of an inductor component of Embodiment 2 of the present disclosure;

FIG. 4 is a schematic sectional view illustrating an example of an inductor component of Embodiment 3 of the present disclosure; and

FIG. 5 is a schematic sectional view illustrating an example of an inductor component of Embodiment 4 of the present disclosure.

### DETAILED DESCRIPTION

An inductor component of the present disclosure will be described below. Note that the present disclosure is not limited to the following configurations and may be modified as appropriate within the range not departing from the scope of the present disclosure. In addition, the present disclosure also encompasses combinations of various preferable configurations to be described below.

The respective embodiments discussed below are mere examples. Needless to say, it is possible to partially replace or combine configurations demonstrated in different embodiments. In Embodiment 2 and subsequent embodiments, description of items common to Embodiment 1 will be omitted and different features will be mainly discussed.

Notably, the same operations and effects owing to the same configurations will not be repeatedly mentioned in every embodiment.

The following description will adopt the expression “inductor component of the present disclosure” in a case where it is not necessary to specify a particular embodiment.

The drawings described below are schematic diagrams, and dimensions, scales such as aspect ratios, and other features may be different from those of actual products.

In the present specification, terms indicating relations among elements (such as “parallel”, “perpendicular”, and “orthogonal”) and terms indicating shapes of the elements not only mean strict and literal aspects but also mean virtually equivalent ranges such as ranges covering tolerances of several percent.

An inductor component of the present disclosure includes a base body including an insulating layer, internal wiring provided inside the base body and constituting a coil spirally wound by electrically coupling at least part of the internal wiring, and an outer electrode electrically coupled to the coil. The insulating layer is provided with a groove starting from an interface, as a point of origin, between the internal wiring and the insulating layer and extending obliquely with respect to a surface of the internal wiring.

### Embodiment 1

An example of an inductor component of the present disclosure will be described below as an inductor component of Embodiment 1 of the present disclosure.

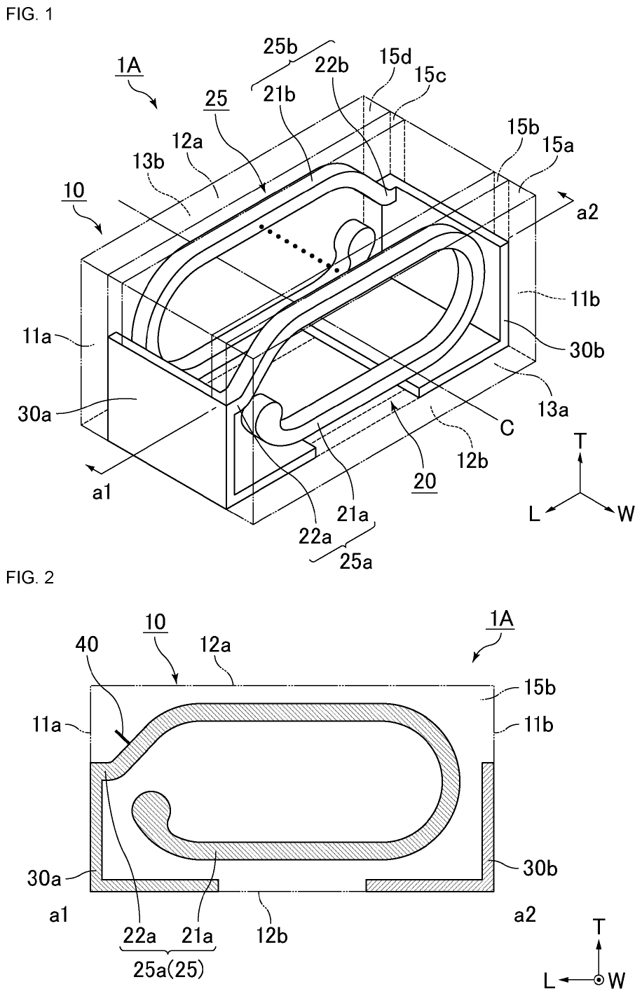

FIG. 1 is a schematic perspective view illustrating an example of the inductor component of Embodiment 1 of the present disclosure.

An inductor component 1A illustrated in FIG. 1 includes a base body 10, a coil 20, a first outer electrode 30a, and a second outer electrode 30b.

In the present specification, a longitudinal direction, a height direction, and a width direction will be defined as directions indicated by signs L, T, and W, respectively, as illustrated in FIG. 1 and the like. Here, the longitudinal direction L, the height direction T, and the width direction W are orthogonal to one another.

As illustrated in FIG. 1, in the inductor component 1A, surfaces of the base body 10 include an end surface 11a and an end surface 11b that are opposed to each other in the longitudinal direction L, a top surface 12a and a bottom surface 12b that are opposed to each other in the height direction T, and a side surface 13a and a side surface 13b that are opposed to each other in the width direction W. In the inductor component 1A, the width direction W is parallel to a coil axis direction of the coil 20. That is to say, in the inductor component 1A, the surfaces of the base body 10 include the bottom surface 12b parallel to the coil axis direction, and the top surface 12a opposed to the bottom surface 12b in the height direction T that is orthogonal to the coil axis direction.

In the present embodiment, the coil axis direction will be defined as a direction parallel to the width direction W unless otherwise stated.

In the inductor component 1A, the bottom surface 12b of the base body 10 is a mounting surface. To be more precise, the bottom surface 12b of the base body 10 is a mounting surface opposed to a mounting object (such as a substrate) at the time of mounting of the inductor component 1A. Therefore, in the inductor component 1A, the mounting surface of the base body 10, that is, the bottom surface 12b of the base body 10 is parallel to the coil axis direction.

At least one of the surfaces of the base body 10, that is, at least one of the end surface 11a, the end surface 11b, the top surface 12a, the bottom surface 12b, the side surface 13a, and the side surface 13b may be provided with marking for facilitating identification of the respective surfaces.

The end surface 11a and the end surface 11b of the base body 10 need not be exactly orthogonal to the longitudinal direction L. The top surface 12a and the bottom surface 12b of the base body 10 need not be exactly orthogonal to the height direction T. Moreover, the side surface 13a and the side surface 13b of the base body 10 need not be exactly orthogonal to the width direction W.

As illustrated in FIG. 1, the base body 10 has a rectangular parallelepiped shape, for example.

In the present specification, the rectangular parallelepiped shape only needs to be such a shape that is substantially parallelepiped. For example, such a shape may include a substantially rectangular parallelepiped shape of which corner portions and ridge line portions are rounded as will be described later.

The corner portions and the ridge line portions of the base body 10 are preferably rounded. A corner portion of the base body 10 is a portion where three surfaces of the base body 10 meet. A ridge line portion of the base body 10 is a portion where two surfaces of the base body 10 meet.

As illustrated in FIG. 1, the base body 10 includes insulating layers.

In the example illustrated in FIG. 1, the base body 10 is formed by laminating the insulating layers in the coil axis direction.

In the example illustrated in FIG. 1, the insulating layers include an insulating layer 15a, an insulating layer 15b, an insulating layer 15c, and an insulating layer 15d.

Although not illustrated in FIG. 1, at least one insulating layer is present between the insulating layer 15b and the insulating layer 15c in the coil axis direction.

Although FIG. 1 illustrates boundaries of the insulating layers for the convenience of explanation, these boundaries do not clearly appear as a matter of fact.

Examples of an insulating material constituting the insulating layers include a glass material containing borosilicate glass as a major component, a ceramic material, an organic material such as epoxy resin, fluororesin, and polymer resin, a composite material such as glass epoxy resin, and the like. A material having a small dielectric constant and a small dielectric loss is particularly preferable as the insulating material.

The insulating materials constituting the insulating layers may be the same as one another, different from one another, or partially different from one another.

Dimensions in the coil axis direction of the insulating layers may be the same as one another, different from one another, or partially different from one another.

As illustrated in FIG. 1, the coil 20 is provided inside the base body 10 and spirally wound in the coil axis direction.

The coil axis direction of the coil 20 is a direction in which a coil axis C of the coil 20 extends, which is parallel to the bottom surface 12b being the mounting surface of the base body 10 as mentioned above.

The coil 20 is formed in the spirally wound state by electrically coupling at least part of internal wiring 25 provided inside the base body 10.

The internal wiring 25 includes a first internal wiring 25a and a second internal wiring 25b.

In the internal wiring 25, the first internal wiring 25a is located at the outermost position on the side surface 13a side of the base body 10 in the coil axis direction.

The first internal wiring 25a is connected to the first outer electrode 30a.

In the internal wiring 25, the second internal wiring 25b is located at the outermost position on the side surface 13b side of the base body 10 in the coil axis direction.

The second internal wiring 25b is connected to the second outer electrode 30b.

Although not illustrated in FIG. 1, at least one internal wiring is present between the first internal wiring 25a and the second internal wiring 25b in the coil axis direction.

The first internal wiring 25a includes a first coil wiring 21a and a first extended wiring 22a.

The second internal wiring 25b includes a second coil wiring 21b and a second extended wiring 22b.

The coil 20 is formed by laminating and electrically coupling at least part of the internal wiring 25 in the coil axis direction, or more specifically, laminating and electrically coupling coil wirings including the first coil wiring 21a and the second coil wiring 21b in the coil axis direction. In other words, each of the first coil wiring 21a and the second coil wiring 21b constitutes the coil 20.

The first coil wiring 21a may have a single-layered structure or a multi-layered structure.

The second coil wiring 21b may have a single-layered structure or a multi-layered structure.

Although not illustrated in FIG. 1, at least one coil wiring is present between the first coil wiring 21a and the second coil wiring 21b in the coil axis direction.

Examples of a conductive material constituting the coil wirings include Ag, Au, Cu, Pd, Ni, Al, an alloy containing at least one element out of these metals, and the like.

The conductive materials constituting the coil wirings may be the same as one another, different from one another, or partially different from one another.

Dimensions in the coil axis direction of the coil wirings may be the same as one another, different from one another, or partially different from one another.

Regarding the coil wirings, dimensions in a direction orthogonal to a direction in which the coil wirings extend when viewed in the coil axis direction, or in other words, widths when viewed in the coil axis direction may be the same as one another, different from one another, or partially different from one another.

Of the coil wirings, coil wirings adjacent to each other in the coil axis direction may be electrically coupled to each other with a connection conductor interposed therebetween. The connection conductor passes through the insulating layer between the adjacent coil wirings in the coil axis direction. In other words, in the coil 20, the coil wirings laminated in the coil axis direction may be electrically coupled to each other with the connection conductor interposed therebetween.

The connection conductor may have a single-layered structure or a multi-layered structure.

Examples of a conductive material constituting the connection conductor include Ag, Au, Cu, Pd, Ni, Al, an alloy containing at least one element out of these metals, and the like.

As described above, in the example illustrated in FIG. 1, the coil 20 is made of three or more coil wirings including the first coil wiring 21a, the second coil wiring 21b, and at least one additional coil wiring. However, it is also possible to form the coil 20 only including the first coil wiring 21a and the second coil wiring 21b by adjusting a location of the connection conductor.

When viewed in the coil axis direction, the coil 20 may have a shape consisting of one or more straight portions, a shape consisting of one or more curved portions, or a shape including one or more straight portions and curved portions. When viewed in the coil axis direction, the coil 20 may have a circular shape, an oval shape, or a polygonal shape, for example.

As illustrated in FIG. 1, the first outer electrode 30a is electrically coupled to one end portion of the coil 20. To be more precise, as illustrated in FIG. 1, the first coil wiring 21a constituting the coil 20 is electrically coupled to the first outer electrode 30a with the first extended wiring 22a interposed therebetween. That is to say, the first extended wiring 22a connects the first coil wiring 21a to the first outer electrode 30a.

The first extended wiring 22a may have a single-layered structure or a multi-layered structure.

As illustrated in FIG. 1, the second outer electrode 30b is electrically coupled to another end portion of the coil 20. To be more precise, as illustrated in FIG. 1, the second coil wiring 21b constituting the coil 20 is electrically coupled to the second outer electrode 30b with the second extended wiring 22b interposed therebetween. That is to say, the second extended wiring 22b connects the second coil wiring 21b to the second outer electrode 30b.

The second extended wiring 22b may have a single-layered structure or a multi-layered structure.

Examples of a conductive material constituting the extended wirings include Ag, Au, Cu, Pd, Ni, Al, an alloy containing at least one element out of these metals, and the like.

The conductive materials constituting the first extended wiring 22a and the second extended wiring 22b may be the same as one another or different from one another.

In the present specification, the extended wiring will be defined as a wiring that extends toward an outer electrode while being tilted relative to a straight portion of a coil wiring on a path that electrically couples the coil wiring to the outer electrode when viewed in the coil axis direction (the example illustrated in FIG. 1, for instance). In this case, the coil wiring and the extended wiring are not present on the same straight line with a junction of both the coil wiring and the extended wirings functioning as a boundary when viewed in the coil axis direction. If no wiring corresponding to the extended wiring as defined above is found when viewed in the coil axis direction, then a wiring not overlapping a circulating portion of the coil (not included in the circulating portion of the coil) when viewed in the coil axis direction will be defined as the extended wiring (an example different from FIG. 1, for instance).

As illustrated in FIG. 1, the first outer electrode 30a is preferably exposed at least to the bottom surface 12b of the base body 10.

In the example illustrated in FIG. 1, the first outer electrode 30a extends from a portion of the bottom surface 12b to a portion of the end surface 11a of the base body 10.

That is to say, in the example illustrated in FIG. 1, the first outer electrode 30a is exposed not only to the portion of the bottom surface 12b of the base body 10 but also to the portion of the end surface 11a of the base body 10.

Here, the first outer electrode 30a may be exposed only to the bottom surface 12b of the base body 10.

As illustrated in FIG. 1, the second outer electrode 30b is preferably exposed at least to the bottom surface 12b of the base body 10.

In the example illustrated in FIG. 1, the second outer electrode 30b extends from a portion of the bottom surface 12b to a portion of the end surface 11b of the base body 10. That is to say, in the example illustrated in FIG. 1, the second outer electrode 30b is exposed not only to the portion of the bottom surface 12b of the base body 10 but also to the portion of the end surface 11b of the base body 10.

Here, the second outer electrode 30b may be exposed only to the bottom surface 12b of the base body 10.

As described above, the first outer electrode 30a and the second outer electrode 30b are provided away from each other in the direction (the longitudinal direction L in this case) orthogonal to the coil axis direction.

When each of the first outer electrode 30a and the second outer electrode 30b is exposed to the bottom surface 12b of the base body 10 serving as the mounting surface, it is easier to improve a mounting performance of the inductor component 1A.

In the example illustrated in FIG. 1, a dimension in the coil axis direction of the first outer electrode 30a is smaller than a dimension in the coil axis direction of the base body 10.

The dimension in the coil axis direction of the first outer electrode 30a may be equal to the dimension in the coil axis direction of the base body 10.

In the example illustrated in FIG. 1, a dimension in the coil axis direction of the second outer electrode 30b is smaller than the dimension in the coil axis direction of the base body 10.

The dimension in the coil axis direction of the second outer electrode 30b may be equal to the dimension in the coil axis direction of the base body 10.

Examples of a conductive material constituting the outer electrodes include Ag, Au, Cu, Pd, Ni, Al, an alloy containing at least one element out of these metals, and the like.

The conductive materials constituting the first outer electrode 30a and the second outer electrode 30b may be the same as one another or different from one another.

The first outer electrode 30a may have a single-layered structure or a multi-layered structure.

The first outer electrode 30a may include an underlying electrode containing the above-mentioned conductive material (such as Ag), a Ni-plated electrode, and a Sn-plated electrode starting from the coil 20 side. In this case, in the first outer electrode 30a, the underlying electrode may form a surface integrated with surfaces of the base body 10 (the end surface 11a and the bottom surface 12b of the base body 10 in FIG. 1), and the Ni-plated electrode and the Sn-plated electrode may protrude from the surfaces of the base body 10 (the end surface 11a and the bottom surface 12b of the base body 10 in FIG. 1) in such a way as to cover the underlying electrode.

The second outer electrode 30b may have a single-layered structure or a multi-layered structure.

The second outer electrode 30b may include an underlying electrode containing the above-mentioned conductive material (such as Ag), a Ni-plated electrode, and a Sn-plated electrode starting from the coil 20 side. In this case, in the second outer electrode 30b, the underlying electrode may form a surface integrated with surfaces of the base body 10 (the end surface 11b and the bottom surface 12b of the base body 10 in FIG. 1), and the Ni-plated electrode and the Sn-plated electrode may protrude from the surfaces of the base body 10 (the end surface 11b and the bottom surface 12b of the base body 10 in FIG. 1) in such a way as to cover the underlying electrode.

FIG. 2 is a schematic sectional view illustrating an example of a cross-section taken along line a1-a2 of the inductor component illustrated in FIG. 1. To be more precise, FIG. 2 illustrates a cross-section including the first internal wiring 25a (the first coil wiring 21a and the first extended wiring 22a) among cross-sections of the inductor component 1A illustrated in FIG. 1 taken along the longitudinal direction L and the height direction T thereof.

As illustrated in FIG. 2, the insulating layer 15b is provided with a groove 40.

As illustrated in FIG. 2, the groove 40 starts from an interface, as a point of origin, between the first internal wiring 25a and the insulating layer 15b, and extends obliquely with respect to a surface of the first internal wiring 25a.

In the present specification, the aspect that the groove starts from the interface, as a point of origin, between the internal wiring and the insulating layer and extends obliquely with respect to the surface of the internal wiring means an aspect that an angle formed between a direction in which the groove extends in the vicinity of the point of origin and a direction along the surface of the internal wiring is greater than or equal to 30°. For example, in the inductor component 1A, the angle formed between the direction in which the groove 40 extends in the vicinity of the interface (the point of origin) between the first internal wiring 25a and the insulating layer 15b and the direction along the surface of the first internal wiring 25a may be greater than or equal to 45° or equal to 90° as long as the angle is greater than or equal to 30°.

In the inductor component 1A, the insulating layer 15b is provided with the groove 40 which starts from the interface, as the point of origin, between the first internal wiring 25a and the insulating layer 15b and extends obliquely with respect to the surface of the first internal wiring 25a. Accordingly, even when a stress occurs on the interface between the first internal wiring 25a and the insulating layer 15b due to a difference in amount of thermal contraction between the first internal wiring 25a and the insulating layer 15b in the manufacturing process of the inductor component 1A, the stress will be released by the groove 40. Hence, in the inductor component 1A, delamination on the interface between the first internal wiring 25a and the insulating layer 15b attributed to the stress occurring on the interface between the first internal wiring 25a and the insulating layer 15b is suppressed even in a case of application of a thermal shock in a firing step in the manufacturing process, a reflow step in the mounting process, and the like, or in a case of application of a physical load (a mechanical load) in other steps. As a consequence, development of cracks along the first internal wiring 25a inside the base body 10 is suppressed.

In the inductor component 1A, even when the stress occurs on the interface between the first internal wiring 25a and the insulating layer 15b as a result of increasing the dimension in the coil axis direction of the first internal wiring 25a in order to, for example, improve coil characteristics by reducing resistance of the first internal wiring 25a, the stress is released by the groove 40 so that the development of cracks inside the base body 10 is suppressed as a consequence.

Therefore, according to the inductor component 1A, it is possible to realize the inductor component that can suppress the development of cracks attributed to the stress occurring on the interface between the first internal wiring 25a and the insulating layer 15b. Moreover, according to the inductor component 1A, it is possible to realize the inductor component that can improve the coil characteristics by reducing the resistance of the first internal wiring 25a while suppressing the development of cracks attributed to the stress occurring on the interface between the first internal wiring 25a and the insulating layer 15b.

In FIG. 2, the groove 40 starts from the interface, as the point of origin, between the first internal wiring 25a and the insulating layer 15b and extends obliquely with respect to the surface of the first internal wiring 25a. Instead, the groove 40 may start from an interface, as the point of origin, between the first internal wiring 25a and an insulating layer (such as the insulating layer 15a) other than the insulating layer 15b and may extend obliquely with respect to the surface of the first internal wiring 25a. Alternatively, the groove 40 may start from an interface, as the point of origin, between an internal wiring (such as the second internal wiring 25b) other than the first internal wiring 25a and an insulating layer (such as the insulating layer 15c) and may extend obliquely with respect to a surface of the internal wiring (such as the second internal wiring 25b) other than the first internal wiring 25a.

As described above, in the inductor component 1A, the groove 40 starts from the interface, as the point of origin, between the internal wiring 25 and the insulating layer (which includes the insulating layer 15a, the insulating layer 15b, the insulating layer 15c, and the insulating layer 15d) and extends obliquely with respect to the surface of the internal wiring 25.

Therefore, according to the inductor component 1A, it is possible to realize the inductor component that can suppress the development of cracks attributed to the stress occurring on the interface between the internal wiring 25 and the insulating layer. Moreover, according to the inductor component 1A, it is possible to realize the inductor component that can improve the coil characteristics by reducing the resistance of the internal wiring 25 while suppressing the development of cracks attributed to the stress occurring on the interface between the internal wiring 25 and the insulating layer.

The inductor component 1A suppresses the development of cracks inside the base body 10, thereby also suppressing deterioration of reliability due to moisture, corrosive gas, and the like entering the inside of the base body 10 via the cracks.

On the other hand, in the inductor component 1A, the internal wiring 25 is connected, at the first internal wiring 25a, or in particular, the first extended wiring 22a, to the surface of the base body 10 with the first outer electrode 30a interposed therebetween. Accordingly, in the inductor component 1A, if a crack occurs inside the base body 10 along the internal wiring 25 due to the stress occurring on the interface between the internal wiring 25 and the insulating layer, the crack may reach the surface of the base body 10 along the first internal wiring 25a, more specifically along the first extended wiring 22a, and the reliability may presumably be deteriorated.

In this regard, as illustrated in FIG. 2, the groove 40 preferably starts from the interface, as the point of origin, between the first internal wiring 25a and the insulating layer 15b and extends obliquely with respect to the surface of the first internal wiring 25a. Moreover, as illustrated in FIG. 2, the groove 40 more preferably starts from the interface, as the point of origin, between the first extended wiring 22a and the insulating layer 15b and extends obliquely with respect to the surface of the first extended wiring 22a.

Specifically, in the inductor component 1A, when the groove 40 starts from the interface, as the point of origin, between the first extended wiring 22a and the insulating layer 15b and extends obliquely with respect to the surface of the first extended wiring 22a, the stress generating on the interface between the first extended wiring 22a and the insulating layer 15b is released by the groove 40. Accordingly, not only the development of cracks along the first extended wiring 22a is suppressed inside the base body 10, but also the cracks are less likely to reach the surface of the base body 10 even in case of the development of the cracks.

The groove 40 may have a straight shape, a curved shape, or a shape that combines a straight shape and a curved shape. In these cases, the groove 40 may have a shape which is bent in the middle.

A position of the groove 40 relative to the internal wiring 25 is not limited to a particular position as long as the groove 40 starts from the interface, as the point of origin, between the internal wiring 25 and the insulating layer and extends obliquely with respect to the surface of the internal wiring 25. For example, when viewed in the coil axis direction, the groove 40 may be provided on an outer peripheral edge side of the internal wiring 25 (the first extended wiring 22a of the first internal wiring 25a in FIG. 2) or provided on an inner peripheral edge side of the internal wiring 25. When viewed in the direction orthogonal to the coil axis direction (the direction including the longitudinal direction L and the height direction T in this case), for example, the groove 40 may be provided on the side surface 13a side of the base body 10 (a near side of the sheet in FIG. 2) or provided on the side surface 13b side of the base body 10 (a far side of the sheet in FIG. 2) relative to the surface of the internal wiring 25.

The direction in which the groove 40 extends is not limited to a particular direction as long as the groove 40 starts from the interface, as the point of origin, between the internal wiring 25 and the insulating layer and extends obliquely with respect to the surface of internal wiring 25. For example, the groove 40 may extend in the coil axis direction, may extend in the direction orthogonal to the coil axis direction, or may extend in a different direction from these directions.

A maximum width of the groove 40 is preferably less than or equal to 0.25 μm.

By setting the maximum width of the groove 40 less than or equal to 0.25 μm, the width of the groove 40 becomes sufficiently smaller than conductive coarse grains contained in photosensitive conductive paste used for forming the internal wiring 25 as will be described later. Thus, the conductive material constituting the internal wiring 25 is kept from entering the groove 40 in the firing step in the manufacturing process of the inductor component 1A. When the conductive material constituting the internal wiring 25 is kept from entering the groove 40, the shape of the groove 40 is maintained. Moreover, the exposure of the internal wiring 25 to the surface of the base body 10 via the groove 40 is suppressed and a short circuit of adjacent internal wirings (coil wirings) via the groove 40 is also suppressed.

The maximum width of the groove 40 is preferably greater than or equal to 0.020 μm.

The width of the groove is determined as described below. First, the inductor component is subjected to a process (such as a polishing process and a cutting process) until the internal wiring is exposed, thereby exposing a cross-section including the interface between the internal wiring and the insulating layer. Then, regarding the groove provided at the interface, as the point of origin, between the internal wiring and the insulating layer, the dimension in the direction orthogonal to the direction in which the groove extends is measured by observing the above-mentioned cross-section with a field emission scanning electron microscope (FE-SEM) or the like, and the dimension is determined as the width of the groove. It is also possible to say that the width of the groove is determined as the dimension in the direction orthogonal to a direction in which a length of the groove is determined as described below. The maximum value of the widths of the groove measured as described above is determined as the maximum width of the groove.

A maximum length of the groove 40 is preferably less than or equal to 1.75 μm.

By setting the maximum length of the groove 40 less than or equal to 1.75 μm, the length of the groove 40 becomes sufficiently smaller than a distance between the surface of the internal wiring 25 and the surface of the base body 10. Thus, even when the conductive material constituting the internal wiring 25 enters the groove 40 in the firing step in the manufacturing process of the inductor component 1A, the internal wiring 25 is kept from being exposed to the surface of the base body 10 via the groove 40. When the exposure of the internal wiring 25 to the surface of the base body 10 via the groove 40 is suppressed, the internal wiring 25 is kept from being exposed to the moisture, the corrosive gas, and the like.

In addition, by setting the maximum length of the groove 40 less than or equal to 1.75 μm, the length of the groove 40 becomes sufficiently smaller than a distance between the internal wirings (coil wirings) adjacent to each other. Thus, even when the conductive material constituting the internal wiring 25 enters the groove 40 in the firing step in the manufacturing process of the inductor component 1A, the internal wirings (coil wirings) adjacent to each other are kept from causing a short circuit with the groove 40 interposed therebetween.

The inside of the groove 40 may be hollow, or at least partially filled with the conductive material constituting the internal wiring 25, or at least partially filled with a material different from both the conductive material constituting the internal wiring 25 and the insulating material constituting the insulating layer 15b.

The maximum length of the groove 40 is preferably greater than or equal to 0.3 μm.

The length of the groove is determined as described below. In the inductor component, the cross-section exposed in the course of the determining the width of the groove as described above is observed with the field emission scanning electron microscope or the like, thereby measuring a dimension in the direction in which the groove extends (a direction in which the groove recedes from the internal wiring) regarding the groove provided to start from the interface, as the point of origin, between the internal wiring and the insulating layer. The measured dimension is determined as the length of the groove. The maximum value of the lengths of the groove measured as described above is determined as the maximum width of the groove.

When determining the width and the length of the groove, a cross-section perpendicular to the coil axis direction may be observed as the cross-section of the inductor component. Instead, a cross-section parallel to the coil axis direction may be observed or a cross-section other than these cross-sections may be observed. In the inductor component 1A illustrated in FIG. 1, the cross-section perpendicular to the coil axis direction is a cross-section along the longitudinal direction L and the height direction T. In the inductor component 1A illustrated in FIG. 1, the cross-section parallel to the coil axis direction includes a cross-section along the longitudinal direction L and the width direction W and a cross-section along the height direction T and the width direction W.

The method of observing the cross-section of the inductor component when determining the width and the length of the groove is preferably the above-described method that uses the field emission scanning electron microscope in view of detectability of the groove at high sensitivity. Note that the method of observing the cross-section of the inductor component when determining the width and the length of the groove is not limited to the method that uses the field emission scanning electron microscope, and other methods are also applicable.

In FIG. 2, in order to emphasize the groove 40, the width and the length of the groove 40 are illustrated with relatively large ratios with respect to the sizes of the insulating layers around the internal wiring 25 (such as the distance between the surface of the internal wiring 25 and the surface of the base body 10 and the distance between the internal wirings (coil wirings) adjacent to each other). In reality, however, the sizes of the insulating layers around the internal wiring 25 may be sufficiently larger (by about 10 times, for example) than the width and the length of the groove 40.

The inductor component 1A is manufactured in accordance with the following method, for example.

### Process to Fabricate Mother Multilayer Body

First, an insulating paste layer is formed by repeatedly coating insulating paste that includes a material such as a glass material containing borosilicate glass as a major component by screen printing and the like. The insulating paste layer formed in this step turns into the insulating layer 15a later.

Next, a photosensitive conductive paste layer is formed on the insulating paste layer by coating photosensitive conductive paste that includes Ag or the like as a major metal component by screen printing or the like. The photosensitive conductive paste layer is irradiated with ultraviolet rays or the like while using a photomask, and is subjected to development with an alkaline solution or the like, thereby forming a coil conductor layer, an external conductor layer, and an extended conductor layer connected to the coil conductor layer and the external conductor layer on the insulating paste layer. In this way, the coil conductor layer, the extended conductor layer, and the external conductor layer are formed at multiple locations in accordance with photolithography. The coil conductor layer formed in this step turns into the first coil wiring 21a later. The extended conductor layer formed in this step turns into the first extended wiring 22a that connects the first coil wiring 21a to the first outer electrode 30a. That is to say, an internal conductor layer including the coil conductor layer and the extended conductor layer formed in this step turns into the first internal wiring 25a later. The external conductor layer formed in this step turns into a portion of each of the first outer electrode 30a and the second outer electrode 30b later.

When forming the coil conductor layer, the extended conductor layer, and the external conductor layer, DI exposure (also referred to as direct image exposure or direct writing) that does not use a photomask may be carried out instead of the exposure that uses the photomask.

Next, a new insulating paste layer is formed on the insulating paste layer that has been formed earlier by coating photosensitive insulating paste by screen printing or the like. The newly formed insulating layer is irradiated with ultraviolet rays or the like while using a photomask, and is then subjected to development with an alkaline solution or the like, thereby forming via holes and openings in the insulating paste layer. In this way, the insulating paste layer provided with the via holes and the openings at multiple locations is formed in accordance with the photolithography. The insulating paste layer formed in this step includes an insulating paste layer that turns into the insulating layer 15b later. The via holes formed in this step partially overlap the coil conductor layer formed earlier. The openings formed in this step partially overlap the external conductor layer formed earlier.

When forming the insulating paste layer provided with the via holes and the openings, the DI exposure that does not use a photomask may be carried out instead of the exposure that uses the photomask.

Next, a new photosensitive conductive paste layer is formed on the insulating paste layer that has been formed earlier while forming this photosensitive conductive paste layer inside the via holes and the openings by applying photosensitive conductive paste that includes Ag or the like as a major metal component by screen printing or the like. The photosensitive conductive paste layer is irradiated with ultraviolet rays or the like while using a photomask, and is subjected to development with an alkaline solution or the like. Thus, a connection conductor layer is formed inside the via holes, and a new coil conductor layer connected to the connection conductor layer is formed on the insulating paste layer. Furthermore, a new external conductor layer connected to the external conductor layer that has been formed earlier is formed inside the openings, and the new external conductor layer is further formed on this external conductor layer. The coil conductor layer, the connection conductor layer, and the external conductor layer are formed as described above in accordance with the photolithography. The connection conductor layer formed in this step turns into the connection conductor later to connect the coil wirings being adjacent to each other in the coil axis direction.

When forming the coil conductor layer, the connection conductor layer, and the external conductor layer, the DI exposure that does not use a photomask may be carried out instead of the exposure that uses the photomask.

Thereafter, the insulating paste layers, the coil conductor layers, the connection conductor layers, and the external conductor layers are formed into a predetermined lamination structure by repeating the above-described steps. For example, the coil conductor layers formed in this step include the coil conductor layer that turns into the second coil wiring 21b later.

Note that an extended conductor layer that is connected to the coil conductor layer and the external conductor layer is also formed when forming the coil conductor layer that turns into the second coil wiring 21b later and the external conductor layer located on the same layer as the coil conductor layer. The extended conductor layer formed in this step turns into the second extended wiring 22b later.

Lastly, new insulating paste layers are formed by, for example, repeatedly coating insulating paste that includes a material such as a glass material containing borosilicate glass as a major component by screen printing or the like. The insulating paste layers formed in this step include insulating paste layers that turn into the insulating layer 15c and the insulating layer 15d later.

When forming the insulating paste layers, a pattern of the groove according to the inductor component of the present disclosure can be realized in the inductor component 1A to be obtained later by using, for example, a photomask provided with the pattern of the groove according to the inductor component of the present disclosure. For example, when the insulating paste layer that turns into the insulating layer 15b later is formed, a groove (a groove that is not fully resolved) starting from an interface, as a point of origin, between the insulating paste layer and the internal conductor layer to be turned into the first internal wiring 25a later and extending obliquely with respect to a surface of the internal conductor layer is formed by using a photomask provided with a pattern of the groove that is smaller than a development resolution limit of the photosensitive insulating paste. This makes it possible to realize in the inductor component 1A to be obtained later the groove 40 that starts from the interface, as the point of origin, between the first internal wiring 25a and the insulating layer 15b and extends obliquely with respect to the surface of the first internal wiring 25a.

Here, the above-mentioned development resolution limit of the photosensitive insulating paste is less than or equal to 3 μm in a case of ultraviolet irradiation at a light source wavelength of 365/405 nm, for example.

### A Mother Multilayer Body is Fabricated as Described Above.

The method of forming conductor patterns of the coil conductor layer, the extended conductor layer, the connection conductor layer, and the external conductor layer is not limited to the above-mentioned photolithography, but may be a different method such as a method of printing and laminating conductive paste by using a screen printing plate proved with openings in accordance with a conductor pattern, a method of forming a conductor film in accordance with any of a sputtering method, a vapor deposition method, a method of pressure-bonding a foil, and the like and then etching the conductor film so as to form a conductor pattern, and a method of forming a plated film after forming a negative pattern in accordance with a semi-additive method and then removing unnecessary portions of the plated film by etching or the like so as to form a conductor pattern.

When forming the conductor patterns of the coil conductor layer, the extended conductor layer, the connection conductor layer, and the external conductor layer, a high aspect ratio is realized by forming multiple stages of the conductor patterns. This makes it possible to reduce a loss attributed to resistance at a high frequency wave. A method of forming the multiple stages of the conductor patterns is not limited to a particular method. For example, as mentioned above, the method may be the method of repeatedly laminating the conductor patterns by repeating the steps using the photolithography, a method of repeatedly laminating the conductor patterns formed in accordance with the semi-additive method, a method of laminating the conductor patterns formed in accordance with the semi-additive method and conductor patterns formed by etching a plated film separately obtained by plating growth in a random order, or a method of subjecting a plated film formed in accordance with the semi-additive method further to plating growth.

The conductive material constituting each of the conductor patterns of the coil conductor layer, the extended conductor layer, the connection conductor layer, and the external conductor layer is not limited to the above-mentioned photosensitive conductive paste that includes Ag or the like as the major metal component. For example, the conductive material may be a conductor containing any of Ag, Au, Cu, or other metals formed in accordance with any of the sputtering method, the vapor deposition method, the method of pressure-bonding a foil, the plating method, and the like.

The method of forming the insulating paste layer is not limited to the above-mentioned photolithography. For example, this method may be a method of pressure-bonding a sheet made of an insulating material, a method of spin-coating the insulating material, or a method of spray-coating the insulating material.

The method of forming the insulating paste layer provided with the via holes and the openings is not limited to the above-mentioned photolithography. For example, this method may be a method of forming an insulating film in accordance with any of the method of pressure-bonding the sheet made of the insulating material, the method of spin-coating the insulating material, the method of spray-coating the insulating material, and the like and then providing the via holes and the openings by subjecting the insulating film to laser processing, drilling, or the like.

The insulating material constituting the insulating paste layer is not limited to the above-mentioned glass material containing borosilicate glass as the major component. For example, the insulating material may be any of a ceramic material, an organic material such as epoxy resin, fluororesin, and polymer resin, a composite material such as glass epoxy resin, and the like. A material having a small dielectric constant and a small dielectric loss is particularly preferable as the insulating material.

### Process to Form Base Body, Coil, and Outer Electrodes

First, the mother multilayer body is cut with a dicing machine or the like, and is thus formed into individual pieces of unfired multilayer bodies.

Each unfired multilayer body includes an insulating paste laminated portion formed by laminating the insulating paste layers, a coil conductor laminated portion formed by laminating the coil conductor layers such that the adjacent coil conductor layers are electrically coupled to each other with the connection conductor layer interposed therebetween, and external conductor laminated portions each formed by laminating the external conductor layers.

When obtaining the individual pieces of the unfired multilayer body, the external conductor laminated portions are exposed to two locations on at least a bottom surface of the insulating paste laminated portion included in cut surfaces of the unfired multilayer body.

Next, the multilayer body is formed by firing the unfired multilayer body.

When the unfired multilayer body is fired, the insulating paste layers are formed into the insulating layers whereby the insulating paste laminated portion turns into the base body 10. When the unfired multilayer body is fired, the coil conductor layers are formed into the coil wirings whereby the coil conductor laminated portion turns into the coil 20. Moreover, when the unfired multilayer body is fired, one of the two external conductor laminated portions turns into part of the first outer electrode 30a and the other of the two external conductor laminated portions turns into part of the second outer electrode 30b.

Next, the corner portions and the ridge line portions of the base body 10 may be rounded by subjecting the obtained multilayer body to a barrel polishing process, for example.

Lastly, using the two external conductor laminated portions after the firing as the underlying electrodes, the Ni-plated electrodes and the Sn-plated electrodes are formed in this order on surfaces of the respective underlying electrodes by carrying out a plating process. A thickness of each of the Ni-plated electrodes and the Sn-plated electrodes is set greater than or equal to 2 μm and less than or equal to 10 μm (i.e., from 2 μm to 10 μm), for example.

The first outer electrode 30a and the second outer electrode 30b each provided with the underlying electrode, the Ni-plated electrode, and the Sn-plated electrode in this order from the surface side of the base body 10 are formed as described above. In this case, in the first outer electrode 30a, the underlying electrode may form the surface integrated with the surfaces of the base body 10 (the end surface 11a and the bottom surface 12b of the base body 10 in FIG. 1), and the Ni-plated electrode and the Sn-plated electrode may protrude from the surfaces of the base body 10 (the end surface 11a and the bottom surface 12b of the base body 10 in FIG. 1) in such a way as to cover the underlying electrode. In the second outer electrode 30b, the underlying electrode may form the surface integrated with the surfaces of the base body 10 (the end surface 11b and the bottom surface 12b of the base body 10 in FIG. 1), and the Ni-plated electrode and the Sn-plated electrode may protrude from the surfaces of the base body 10 (the end surface 11b and the bottom surface 12b of the base body 10 in FIG. 1) in such a way as to cover the underlying electrode.

The method of forming the outer electrode is not limited to the method of subjecting the external conductor laminated portion, which is exposed to the cut surface (at least the bottom surface of the insulating paste laminated portion) of the unfired multilayer body, to the plating process as described above. For example, the method may be a method of exposing the external conductor laminated portion to the cut surface (at least the bottom surface of the insulating paste laminated portion) of the unfired multilayer body as described above, then immersing (dipping) the exposed portion of the external conductor laminated portion in the conductive paste or forming a conductive paste film on the exposed portion of the external conductor laminated portion by sputtering, and then carrying out the plating process.

### The Inductor Component 1A is Manufactured as Described Above.

The inductor component 1A is manufactured in 0402 (0.4 mm×0.2 mm×0.2 mm) size, for example. The size of the inductor component 1A is not limited to the 0402 (0.4 mm×0.2 mm×0.2 mm) size.

In the inductor component 1A, the method of realizing the pattern of the groove according to the inductor component of the present disclosure may be the method of using the photomask provided with the pattern of the groove according to the inductor component of the present disclosure when forming the insulating paste layer in the process of fabricating the mother multilayer body as described above, or may be other methods. For example, when the unfired multilayer body is fired in the process of forming the base body, the coil, and the outer electrodes, the stress is caused to remain inside the obtained base body 10 intentionally by increasing an inclination of a temperature drop profile. Moreover, the groove 40 that starts from the interface, as the point of origin, between the first internal wiring 25a and the insulating layer 15b and extends obliquely with respect to the surface of the first internal wiring 25a may be formed by causing a colliding material being a lightweight material to collide with the base body 10 in a predetermined direction, for example. Alternatively, the pattern of the groove according to the inductor component of the present disclosure may be provided by forming the insulating paste layer and then irradiating the insulating paste layer with a laser.

### Embodiment 2

In an inductor component of Embodiment 2 of the present disclosure, when viewing a cross-section including the interface, where the point of origin of the groove is present, between the internal wiring and the insulating layer, the insulating layer is further provided with an additional groove starting from the interface as a point of origin and extending along the surface of the internal wiring without crossing the groove. Except for the aforementioned feature, the inductor component of Embodiment 2 of the present disclosure is the same as the inductor component of Embodiment 1 of the present disclosure.

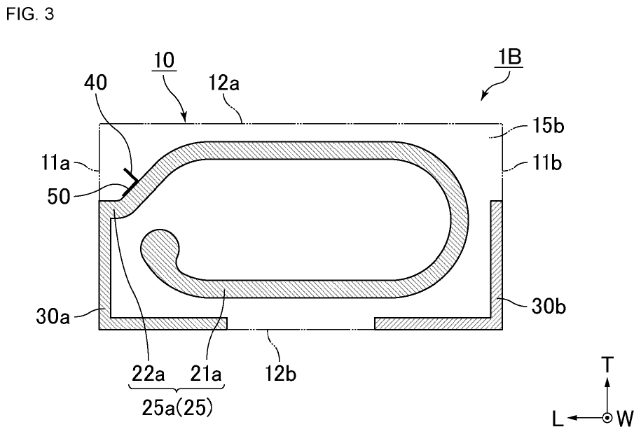

FIG. 3 is a schematic sectional view illustrating an example of the inductor component of Embodiment 2 of the present disclosure.

In an inductor component 1B illustrated in FIG. 3, the insulating layer 15b is further provided with an additional groove 50 in addition to the groove 40.

As illustrated in FIG. 3, when viewing a cross-section including the interface (an outer peripheral edge of the first extended wiring 22a of the first internal wiring 25a in FIG. 3) where the point of origin of the groove 40 is present between the first internal wiring 25a and the insulating layer 15b, the additional groove 50 starts from the interface as the point of origin and extends along the surface of the first internal wiring 25a without crossing the groove 40.

In the present specification, the aspect that the additional groove starts from the interface as the point of origin and extends along the surface of the internal wiring when viewing the cross-section including the interface, where the point of origin of the groove is present, between the internal wiring and the insulating layer means an aspect that an angle formed between a direction in which the additional groove extends in the vicinity of the point of origin and the direction along the surface of the internal wiring is smaller than 30°. For example, in the inductor component 1B, the angle formed between the direction in which the additional groove 50 extends in the vicinity of the interface (the point of origin) between the first internal wiring 25a and the insulating layer 15b and the direction along the surface of the first internal wiring 25a may be less than or equal to 7°, equal to 0°, or not equal to 0° as long as the angle is less than 30°. That is to say, in the inductor component 1B, the direction in which the additional groove 50 extends in the vicinity of the interface (the point of origin) between the first internal wiring 25a and the insulating layer 15b and the direction along the surface of the first internal wiring 25a may be exactly parallel or need not to be exactly parallel.

In the present specification, the aspect that the additional groove does not cross the groove when viewing the cross-section including the interface, where the point of origin of the groove is present, between the internal wiring and the insulating layer means an aspect that the additional groove does not cross the point of origin of the groove at the above-mentioned interface. For example, in the inductor component 1B, when viewing the cross-section including the interface, where the point of origin of the groove 40 is present, between the first internal wiring 25a and the insulating layer 15b, one end portion (an end portion on a far side from the first outer electrode 30a in FIG. 3) of the additional groove 50 close to the point of origin of the groove 40 may be in contact with the point of origin of the groove 40 or need not be in contact therewith (located away therefrom) as long as the additional groove 50 does not cross the point of origin of the groove 40 at the above-mentioned interface.

In the inductor component 1B, the insulating layer 15b is provided with the additional groove 50 that starts from the interface, as the point of origin, between the first internal wiring 25a and the insulating layer 15b and extends along the surface of the first internal wiring 25a. Accordingly, even when a stress occurs on the interface between the first internal wiring 25a and the insulating layer 15b due to a difference in amount of thermal contraction between the first internal wiring 25a and the insulating layer 15b in the manufacturing process of the inductor component 1B, the stress will be released not only by the groove 40, but also by the additional groove 50 in a wider range. Hence, in the inductor component 1B, delamination on the interface between the first internal wiring 25a and the insulating layer 15b attributed to the stress occurring on the interface between the first internal wiring 25a and the insulating layer 15b is sufficiently suppressed. As a consequence, the development of cracks along the first internal wiring 25a inside the base body 10 is sufficiently suppressed.

Moreover, in the inductor component 1B, the additional groove 50 extending along the surface of the first internal wiring 25a does not cross the groove 40, whereby the additional groove 50 is configured to be blocked by the groove 40. Accordingly, not only the additional groove 50 is kept from growth but also the base body 10 is kept from a decrease in strength due to the growth of the additional groove 50.

In FIG. 3, of two end portions of the additional groove 50, the one end portion (the end portion on the far side from the first outer electrode 30a in FIG. 3) of the additional groove 50 is located close to the point of origin of the groove 40. Instead, the other end portion (an end portion on a near side to the first outer electrode 30a in FIG. 3) of the additional groove 50 may be located close to the point of origin of the groove 40.

Alternatively, another groove 40 having a point of origin located close to the other end portion (the end portion on the near side to the first outer electrode 30a in FIG. 3) of the additional groove 50 may be provided in addition to the groove 40 having the point of origin located close to the one end portion (the end portion on the far side from the first outer electrode 30a in FIG. 3) of the additional groove 50.

In FIG. 3, when viewing the cross-section including the interface, where the point of origin of the groove 40 is present, between the first internal wiring 25a and the insulating layer 15b, the additional groove 50 starts from the interface, as the point of origin, between the first internal wiring 25a and the insulating layer 15b and extends along the surface of the first internal wiring 25a without crossing the groove 40. Instead, in a case where the point of origin of the groove 40 is present on an interface between the first internal wiring 25a and an insulating layer (such as the insulating layer 15a) other than the insulating layer 15b, the additional groove 50 may start from the interface, as the point of origin, between the first internal wiring 25a and the insulating layer (such as the insulating layer 15a) other than the insulating layer 15b and extend along the surface of the first internal wiring 25a without crossing the groove 40 when viewing the cross-section including this interface. Alternatively, in a case where the point of origin of the groove 40 is present on an interface between an internal wiring (such as the second internal wiring 25b) other than the first internal wiring 25a and an insulating layer (such as the insulating layer 15c), the additional groove 50 may start from the interface, as the point of origin, between the internal wiring (such as the second internal wiring 25b) other than the first internal wiring 25a and the insulating layer (such as the insulating layer 15c) and extend along the surface of internal wiring (such as the second internal wiring 25b) other than the first internal wiring 25a without crossing the groove 40 when viewing the cross-section including this interface.

As described above, in the inductor component 1B, when viewing the cross-section including the interface, where the point of origin of the groove 40 is present, between the internal wiring 25 and the insulating layer (including the insulating layer 15a, the insulating layer 15b, the insulating layer 15c, and the insulating layer 15d), the additional groove 50 starts from this interface as the point of origin and extends along the surface of the internal wiring 25 without crossing the groove 40.

As illustrated in FIG. 3, when viewing the cross-section including the interface, where the point of origin of the groove 40 is present, between the first internal wiring 25a and the insulating layer 15b, the additional groove 50 starts from the interface as the point of origin and extends along the surface of the first internal wiring 25a without crossing the groove 40. In particular, as illustrated in FIG. 3, when viewing the cross-section including the interface, where the point of origin of the groove 40 is present, between the first extended wiring 22a and the insulating layer 15b, the additional groove 50 preferably starts from the interface as the point of origin and extends along the surface of the first extended wiring 22a without crossing the groove 40.

The additional groove 50 may have a straight shape, a curved shape, or a shape that combines a straight shape and a curved shape. In these cases, the additional groove 50 may have a shape which is bent in the middle.

A position of the additional groove 50 relative to the internal wiring 25 is not limited to a particular position as long as the additional groove 50 starts from the interface, as the point of origin, between the internal wiring 25 and the insulating layer where the point of origin of the groove 40 is present and extends along the surface of the internal wiring 25 without crossing the groove 40 when viewing the cross-section including the interface. For example, when viewed in the coil axis direction, the additional groove 50 may be provided on the outer peripheral edge side of the internal wiring 25 (the first extended wiring 22a of the first internal wiring 25a in FIG. 3) or provided on the inner peripheral edge side of the internal wiring 25. When viewed in the direction orthogonal to the coil axis direction (the direction including the longitudinal direction L and the height direction T in this case), for example, the additional groove 50 may be provided on the side surface 13a side of the base body 10 (a near side of the sheet in FIG. 3) or provided on the side surface 13b side (a far side of the sheet in FIG. 3) relative to the surface of the internal wiring 25.

A direction in which the additional groove 50 extends is not limited to a particular direction as long as the additional groove 50 starts from the interface, as the point of origin, between the internal wiring 25 and the insulating layer where the point of origin of the groove 40 is present and extends along the surface of the internal wiring 25 without crossing the groove 40 when viewing the cross-section including the interface. For example, the additional groove 50 may extend in the coil axis direction, extend in the direction orthogonal to the coil axis direction, or extend in a direction other than these directions.

### Embodiment 3

In an inductor component of Embodiment 3 of the present disclosure, a width of the groove on the internal wiring side is larger than a width on an opposite side from the internal wiring side in the direction in which the groove extends. Except for the aforementioned feature, the inductor component of Embodiment 3 of the present disclosure is the same as the inductor component of Embodiment 1 of the present disclosure.

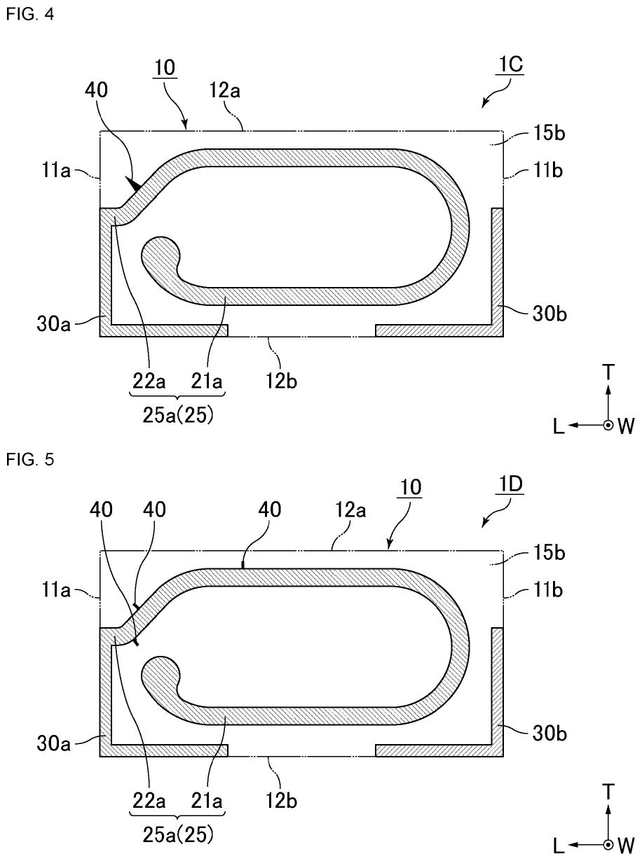

FIG. 4 is a schematic sectional view illustrating an example of the inductor component of Embodiment 3 of the present disclosure.

In an inductor component 1C illustrated in FIG. 4, the width of the groove 40 on the first internal wiring 25a side is larger than the width on an opposite side from the first internal wiring 25a in the direction in which the groove 40 extends.

In the inductor component 1C, the width of the groove 40 on the first internal wiring 25a side is larger than the width on the opposite side from first internal wiring 25a in the direction in which the groove 40 extends. Accordingly, the width of the groove 40 grows larger in the vicinity of the interface between the first internal wiring 25a and the insulating layer 15b on which the stress occurring due to the difference in amount of thermal contraction between the first internal wiring 25a and the insulating layer 15b is apt to concentrate (apt to grow larger). Thus, the stress is more likely to be released by the groove 40. Moreover, in the inductor component 1C, the width of the groove 40 is large at a position close to the first internal wiring 25a but is small at a position far from the first internal wiring 25a. Accordingly, provision of the above-mentioned groove 40 is less likely to cause a decrease in strength of the base body 10 and sufficient strength is therefore secured.

The width of the groove 40 may be gradually increased as illustrated in FIG. 4 or may be increased stepwise from the opposite side from the first internal wiring 25a to the first internal wiring 25a side (toward the first internal wiring 25a) in the direction in which the groove 40 extends. For example, an external shape of the groove 40 may be formed into a tapered shape as illustrated in FIG. 4 or into a stepped shape such that the width on the first internal wiring 25a side is larger than the width on the opposite side from the first internal wiring 25a.

In FIG. 4, the groove 40 is provided to start from the interface, as the point of origin, between the first internal wiring 25a and the insulating layer 15b. In the meantime, even when the groove 40 is provided to start from an interface, as the point of origin, between the first internal wiring 25a and an insulating layer (such as the insulating layer 15a) other than the insulating layer 15b or to start from an interface, as the point of origin, between an internal wiring (such as the second internal wiring 25b) other than the first internal wiring 25a and an insulating layer (such as the insulating layer 15c), the width of the groove 40 on the internal wiring 25 side may be larger than the width on an opposite side from the internal wiring 25 in the direction in which the groove 40 extends.

### Embodiment 4

In an inductor component of Embodiment 4 of the present disclosure, the insulating layer is provided with multiple grooves. Except for the aforementioned feature, the inductor component of Embodiment 4 of the present disclosure is the same as the inductor component of Embodiment 1 of the present disclosure.

FIG. 5 is a schematic sectional view illustrating an example of the inductor component of Embodiment 4 of the present disclosure.

In an inductor component 1D illustrated in FIG. 5, the insulating layer 15b is provided with multiple grooves 40.

Since the inductor component 1D is provided with the multiple grooves 40, the stress occurring on the interface between the first internal wiring 25a and the insulating layer 15b is released more as compared to the case of providing the single groove 40. Accordingly, this configuration suppresses the development of cracks inside the base body 10 more appropriately.

The number of the grooves 40 is not limited to three as illustrated in FIG. 5, but may instead be two or greater than or equal to four.

Shapes of the grooves 40 may be the same as one another, different from one another, or partially different from one another. For example, the shapes of the grooves 40 may adopt any combination selected from the group constituting of a straight shape, a curved shape, a shape that combines a straight shape and a curved shape, and a shape which is bent in the middle in any of these cases.

Positions of the grooves 40 relative to the internal wiring 25 may be the same as one another, different from one another, or partially different from one another. For example, the positions of the grooves 40 relative to the internal wiring 25 may adopt any combination selected from the group consisting of an outer peripheral edge side of the internal wiring 25 (the first internal wiring 25a in FIG. 5) when viewed in the coil axis direction, an inner peripheral edge side of the internal wiring 25 when viewed in the coil axis direction, the side surface 13a side of the base body 10 (a near side of the sheet in FIG. 5) relative to the surface of the internal wiring 25 when viewed in the direction orthogonal to the coil axis direction, and the side surface 13b side of the base body 10 (a far side of the sheet in FIG. 5) relative to the surface of the internal wiring 25 when viewed in the direction orthogonal to the coil axis direction.

Directions in which the grooves 40 extend may be the same as one another, different from one another, or partially different from one another. For example, the directions in which the grooves 40 extend may adopt any combination selected from the group consisting of the coil axis direction, the direction orthogonal to the coil axis direction, and directions other than these directions.

In the example illustrated in FIG. 5, some (two in FIG. 5) of the grooves 40 are provided to start from the interface, as the point of origin, between the first extended wiring 22a and the insulating layer 15b, and the rest (one in FIG. 5) is provided to start from an interface, as the point of origin, between the first coil wiring 21a and the insulating layer 15b. Instead, all of the grooves 40 may be provided to start from the interface, as the point of origin, between the first extended wiring 22a and the insulating layer 15b, or all of the grooves 40 may be provided to start from the interface, as the point of origin, between the first coil wiring 21a and the insulating layer 15b.

Of the widths of the grooves 40, the maximum width is preferably less than or equal to 0.25 μm.

Of the widths of the grooves 40, the maximum width is preferably greater than or equal to 0.020 μm.

Of the lengths of the grooves 40, the maximum length is preferably less than or equal to 1.75 μm.

Of the lengths of the grooves 40, the maximum length is preferably greater than or equal to 0.3 μm.

Embodiment 1, Embodiment 2, Embodiment 3, and Embodiment 4 described above have exemplified an aspect in which the mounting surface of the base body is parallel to the coil axis direction. Instead, these embodiments may adopt an aspect in which the mounting surface of the base body is perpendicular to the coil axis direction.

### The Present Application Discloses the Following Contents.

<1> An inductor component including a base body including an insulating layer; internal wiring provided inside the base body and constituting a coil spirally wound by electrically coupling at least part of the internal wiring; and an outer electrode electrically coupled to the coil. The insulating layer is provided with a groove starting from an interface, as a point of origin, between the internal wiring and the insulating layer and extending obliquely with respect to a surface of the internal wiring.

<2> The inductor component according to <1>, in which the outer electrode includes a first outer electrode electrically coupled to one end portion of the coil, and the internal wiring includes a first internal wiring connected to the first outer electrode. Also, the groove starts from an interface, as the point of origin, between the first internal wiring and the insulating layer and extends obliquely with respect to a surface of the first internal wiring.

<3> The inductor component according to <2>, in which the first internal wiring includes a first coil wiring constituting the coil, and a first extended wiring that connects the first coil wiring to the first outer electrode. The groove starts from an interface, as the point of origin, between the first extended wiring and the insulating layer and extends obliquely with respect to a surface of the first extended wiring.

<4> The inductor component according to any one of <1> to <3>, in which when viewing a cross-section including the interface, where the point of origin of the groove is present, between the internal wiring and the insulating layer, the insulating layer is further provided with an additional groove that starts from the interface as a point of origin and extends along the surface of the internal wiring without crossing the groove.

<5> The inductor component according to any one of <1> to <4>, in which a width of the groove close to the internal wiring is larger than a width of the groove opposite from the internal wiring in a direction in which the groove extends.

<6> The inductor component according to any one of <1> to <5>, in which a maximum width of the groove is less than or equal to 0.25 μm.

<7> The inductor component according to any one of <1> to <6>, in which a maximum length of the groove is less than or equal to 1.75 μm.

What is claimed is:

1. An inductor component comprising:
a base body including an insulating layer;
internal wiring inside the base body and configuring a coil spirally wound by electrically connecting at least part of the internal wiring; and
an outer electrode electrically connected to the coil, wherein
the insulating layer includes a groove starting from an interface, as a starting point, between the internal wiring and the insulating layer and extending obliquely with respect to a surface of the internal wiring.

2. The inductor component according to claim 1, wherein
the outer electrode includes a first outer electrode electrically connected to one end portion of the coil,
the internal wiring includes a first internal wiring connected to the first outer electrode, and
the groove starts from an interface, as the starting point, between the first internal wiring and the insulating layer and extends obliquely with respect to a surface of the first internal wiring.

3. The inductor component according to claim 2, wherein
the first internal wiring includes
a first coil wiring configuring the coil, and
a first extended wiring that connects the first coil wiring to the first outer electrode, and
the groove starts from an interface, as the starting point, between the first extended wiring and the insulating layer and extends obliquely with respect to a surface of the first extended wiring.

4. The inductor component according to claim 1, wherein
when viewed in a cross-section including the interface between the internal wiring and the insulating layer, where the starting point of the groove is present, the insulating layer further includes an additional groove that starts from the interface as the starting point and extends along the surface of the internal wiring without crossing the groove.

5. The inductor component according to claim 1, wherein
a width of the groove close to the internal wiring is larger than a width of the groove opposite from the internal wiring in a direction in which the groove extends.

6. The inductor component according to claim 1, wherein
a maximum width of the groove is less than or equal to 0.25 μm.

7. The inductor component according to claim 1, wherein
a maximum length of the groove is less than or equal to 1.75 μm.
